(19) United States
(12) Patent Application Publication
(10) Pub. No.: US 2025/0360935 A1
(43) Pub. Date: Nov. 27, 2025

(54) SYSTEM, METHOD, AND COMPUTER PROGRAM FOR VEHICLE SOFTWARE DEVELOPMENT

(71) Applicant: TOYOTA JIDOSHA KABUSHIKI KAISHA, Toyota-shi (JP)

(72) Inventor: Caleb MCGARY, Tokyo (JP)

(73) Assignee: TOYOTA JIDOSHA KABUSHIKI KAISHA, Toyota-shi (JP)

(21) Appl. No.: 18/673,465

(22) Filed: May 24, 2024

(51) Int. Cl. B60W 50/06; G06F 21/60

(52) U.S. Cl. CPC B60W 50/06; G06F 21/602

(57) ABSTRACT

Provided are system, method, and device for performs vehicle software development. According to example embodiments, the system may include: a memory storage storing computer-executable instructions; and at least one processor communicatively coupled to the memory storage, wherein the at least one processor may be configured to execute the instructions to: receive a cryptographic key; validate the received cryptographic key; in response to successfully validating the received cryptographic key, initiate a development configuration of a vehicle, wherein the development configuration may include a primary electronic control unit (ECU) in the vehicle including a plurality of partitions, and a secondary ECU in the vehicle serving as a ramdisk of the primary ECU; and in response to detecting a removal of the received cryptographic key from the vehicle, end the development configuration and delete a memory of the secondary ECU.

### TECHNICAL FIELD

Systems, methods, and computer programs consistent with example embodiments of the present disclosure relate to a vehicle software development.

### BACKGROUND

Modern vehicles are capable of performing a wide range of complex functions, such as generating telemetry data, transmitting and receiving data via the internet, and the like. In order for the vehicles to perform the above functions, said vehicles are inherently connected to an upstream server. With the above functions, modern vehicles are able to create entertaining and rich experience for the drivers via interactive applications as they drive the vehicles.

In the related art, in order to develop and test such interactive applications on a vehicle, specialized hardware and tooling may be required.

However, the above approaches for developing and testing the applications (vehicle software) in the related art may have at least the following shortcomings. Since the specialized hardware and tooling are required, the development and testing of the applications on a vehicle may be bespoke, challenging, and costly for developers. To avoid such issues, developers may be forced to rely on existing frameworks such as Android Auto or Apple CarPlay. However, such solutions have limited functionalities as they do not have a way of writing and testing applications directly on the vehicle.

Accordingly, there is a need for a system that is able to write and test applications directly on the vehicle, without requiring specialized hardware and tooling.

### SUMMARY

Example embodiments of the present disclosure performs vehicle software development. As such, example embodiments of the present disclosure allows for applications to be written and tested directly on the vehicle, without requiring specialized hardware and tooling. According to example embodiments, a system is provided. The system may include:

a memory storage storing computer-executable instructions; and at least one processor communicatively coupled to the memory storage, wherein the at least one processor may be configured to execute the instructions to: receive a cryptographic key; validate the received cryptographic key; in response to successfully validating the received cryptographic key, initiate a development configuration of a vehicle, wherein the development configuration may include a primary electronic control unit (ECU) in the vehicle including a plurality of partitions, and a secondary ECU in the vehicle serving as a ramdisk of the primary ECU; and in response to detecting a removal of the received cryptographic key from the vehicle, end the development configuration and delete a memory of the secondary ECU.

According to example embodiments, the at least one processor may be configured to execute the instructions to initiate the development configuration by selecting the primary ECU and the secondary ECU based on a predefined configuration file.

According to example embodiments, the primary ECU and the secondary ECU may be communicatively coupled via a Peripheral Component Interconnect (PCI) Express interface.

According to example embodiments, the at least one processor may be configured to execute the instructions to initiate the development configuration by unlocking a portion of the plurality of partitions of the primary ECU.

According to example embodiments, the unlocked portion of the plurality of partitions of the primary ECU may include one or more of: a partition including a virtual machine related to non-safety related functionalities of the vehicle, a partition including a virtual machine related to software development framework, and a partition including user data.

According to example embodiments, the at least one processor may be configured to execute the instructions to initiate the development configuration further by hosting a development environment at the secondary ECU.

According to example embodiments, the primary ECU may be associated with a plurality of functions of the vehicle, and wherein the plurality of functions may be accessed by a user via the development environment and the unlocked portion of the plurality of partitions of the primary ECU.

According to example embodiments, the at least one processor may be configured to execute the instructions to host the development environment by: receiving one or more instructions storing a function of the primary ECU at the development environment from a user; storing the function at the secondary ECU; and exporting the stored function to a device.

According to example embodiments, the at least one processor may be configured to execute the instructions to host the development environment by: receiving one or more instructions accessing a function of the primary ECU at the development environment from a user; determining whether the function is stored in the secondary ECU; in response to determining that the function is stored in the secondary ECU, accessing the function stored in the secondary ECU;

in response to determining that the function is not stored in the secondary ECU, accessing the function stored in the primary ECU; and transmitting a result of accessing the function to the development environment.

According to example embodiments, a method is provided. The method may include: receiving a cryptographic key; validating the received cryptographic key; in response to successfully validating the received cryptographic key, initiating a development configuration of a vehicle, wherein the development configuration may include a primary electronic control unit (ECU) in the vehicle including a plurality of partitions, and a secondary ECU in the vehicle serving as a ramdisk of the primary ECU; and in response to detecting a removal of the received cryptographic key from the vehicle, ending the development configuration and deleting a memory of the secondary ECU.

According to example embodiments, the initiating the development configuration may include selecting the primary ECU and the secondary ECU based on a predefined configuration file.

According to example embodiments, the primary ECU and the secondary ECU may be communicatively coupled via a Peripheral Component Interconnect (PCI) Express interface.

According to example embodiments, the initiating the development configuration may include unlocking a portion of the plurality of partitions of the primary ECU.

According to example embodiments, the unlocked portion of the plurality of partitions of the primary ECU may include one or more of: a partition including a virtual machine related to non-safety related functionalities of the vehicle, a partition including a virtual machine related to software development framework, and a partition including user data.

According to example embodiments, the initiating the development configuration may further include hosting a development environment at the secondary ECU.

According to example embodiments, the primary ECU may be associated with a plurality of functions of the vehicle, and wherein the plurality of functions may be accessed by a user via the development environment and the unlocked portion of the plurality of partitions of the primary ECU.

According to example embodiments, the hosting the development environment may include: receiving one or more instructions storing a function of the primary ECU at the development environment from a user; storing the function at the secondary ECU; and exporting the stored function to a device.

According to example embodiments, the hosting the development environment may include: receiving one or more instructions accessing a function of the primary ECU at the development environment from a user; determining whether the function is stored in the secondary ECU; in response to determining that the function is stored in the secondary ECU, accessing the function stored in the secondary ECU; in response to determining that the function is not stored in the secondary ECU, accessing the function stored in the primary ECU; and transmitting a result of accessing the function to the development environment.

According to example embodiments, a non-transitory computer-readable recording medium is provided. The non-transitory computer-readable recording medium may have recorded thereon instructions executable by at least one processor to cause the at least one processor to perform a method including: receiving a cryptographic key; validating the received cryptographic key; in response to successfully validating the received cryptographic key, initiating a development configuration of a vehicle, wherein the development configuration may include a primary electronic control unit (ECU) in the vehicle including a plurality of partitions, and a secondary ECU in the vehicle serving as a ramdisk of the primary ECU; and in response to detecting a removal of the received cryptographic key from the vehicle, ending the development configuration and deleting a memory of the secondary ECU.

According to example embodiments, the initiating the development configuration may include selecting the primary ECU and the secondary ECU based on a predefined configuration file.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of an example system configuration for developing a vehicle software, according to one or more embodiments;

FIG. 2 illustrates a block diagram of example components in a primary ECU, according to one or more embodiments;

FIG. 3 illustrates a block diagram of example components in a Vehicle Software Development (VSD) system, according to one or more embodiments;

FIG. 4 illustrates a flow diagram of an example method for developing a vehicle software, according to one or more embodiments;

FIG. 5 illustrates a flow diagram of an example method for initiating a development configuration of a vehicle, according to one or more embodiments;

FIG. 6A illustrates a flow diagram of an example method for hosting a development environment at a secondary ECU, according to one or more embodiments;

FIG. 6B illustrates a flow diagram of an example method for hosting a development environment at a secondary ECU, according to one or more embodiments; and

FIG. 7 illustrates diagram of example interactions between a primary ECU, a secondary ECU, and a user device, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the vehicle software development system of the present disclosure, according to one or more embodiments, are provided in the following.

### Example System Architecture

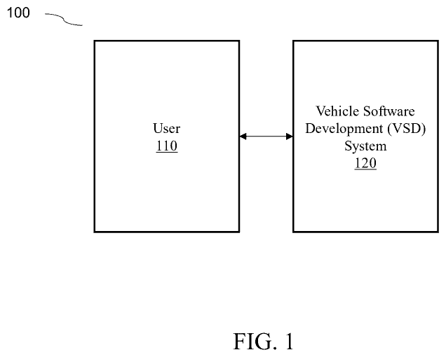

FIG. 1 illustrates a block diagram of an example system configuration 100 for developing a vehicle software, according to one or more embodiments. As illustrated in FIG. 1, system configuration 100 may include a user 110 and a Vehicle Software Development (VSD) System 120.

The VSD system 120 may include an apparatus, a system, a platform, a module, or the like, which may be configured to perform one or more operations or actions for developing a vehicle software. According to example embodiments, the VSD system 120 may include a vehicle. According to example embodiments, the VSD system 120 may be installed in a vehicle. According to example embodiments, the VSD system 120 may include a plurality of electronic control units (ECUs) of a vehicle, where each of the plurality of ECUs may be configured to control one or more electrical systems of the vehicle. For example, the plurality of ECUs may include an In-Vehicle Infotainment (IVI) ECU that is configured to control electrical systems related to the infotainment within the vehicle.

According to example embodiments, the VSD system may be configured with a development configuration and a production configuration of a vehicle.

The development configuration of the vehicle may refer to a configuration of the vehicle where only a portion of subsystems of the vehicle are unlocked for access by the user 110 (software developer) to perform vehicle software development on the vehicle. In particular, the development configuration may specify one ECU from among the plurality of ECUs within the vehicle as a primary ECU, and another one ECU from among the plurality of ECUs within the vehicle as a secondary ECU. When the VSD system (vehicle) is in the development configuration, only the primary ECU and the secondary ECU may be booted, while the remaining ECUs within the vehicle may not be booted. For example, the Cockpit Domain Controller (C-DC) ECU may be selected as the primary ECU for a Battery Electric Vehicle (BEV), while the In-Vehicle Infotainment (IVI) ECU or the Instrument Cluster (IC) ECU may be selected as the primary ECU for a non-BEV.

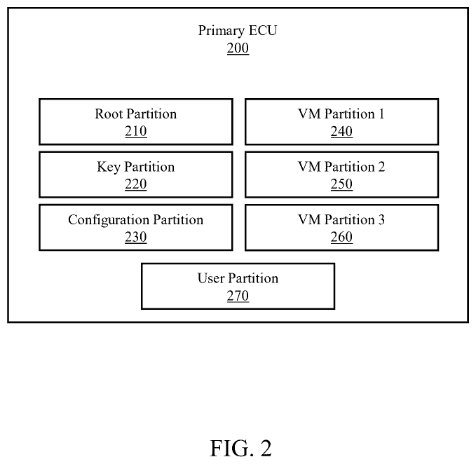

The primary ECU may serve as an access point for the user to access various functions of the vehicle when developing a software for the vehicle. FIG. 2 illustrates a block diagram of example components in a primary ECU 200, according to one or more embodiments. As shown in FIG. 2, the primary ECU 200 may include a root partition 210, key partition 220, configuration partition 230, virtual machine (VM) partition 1 240, VM partition 2 250, VM partition 3 260, and user partition 270.

The root partition 210 may contain an operating system (e.g., type 1 hypervisor) that boots the other systems that are required to run the vehicle. The key partition 220 may contain encrypted keys for unlocking each of the partitions of the primary ECU 200. The configuration partition 230 may contain configuration data related to initiation (start) of each of the virtual machines in the partitions of the primary ECU 200 (e.g., the virtual machines in VM partition 1 240, VM partition 2 250, and VM partition 3 260). The VM partition 1 may contain a VM related to Real-Time Operating System (RTOS) as well as any safety related functionalities of the vehicle. The VM partition 2 250 may contain a VM related to any non-safety related functionalities, such as IVI multimedia. The VM partition 3 260 may contain a VM related to software development frameworks, such as Android Auto and Apple CarPlay. The user partition 270 may contain user data (data of the driver).

According to example embodiments, when the VSD system (vehicle) is in the development configuration, only a portion of the plurality of partitions of the primary ECU may be unlocked for access by the user 110 (software developer) to perform vehicle software development on the vehicle. For example, only the root partition 210, key partition 220, configuration partition 230, VM partition 2 250, VM partition 3 260, and user partition 270 may be unlocked in the development configuration. According to example embodiments, the disk of the primary ECU 200 may utilize whole disk encryption, while each partition may be encrypted separately with different encryption keys. For example, the user partition 270 may be associated with a personal identification number (PIN), where the user partition 270 may be unlocked in the development mode when the user 110 provides a corresponding PIN.

According to example embodiments, the primary ECU may be restarted as required. According to example embodiments, the primary ECU may further include a Replay Protected Memory Block (RPMB) and electronic fuse (efuse). The content of the RPMB may be overwritten but may not be erased. Such configuration prevents a downgrade attack (i.e., rolling back to an older version or vulnerable version) during development. The current version of software on the vehicle may be stored in the RPMB prior to booting in the development configuration, and the development configuration may not permit writing to RPMB.

It may be understood that the above descriptions are provided for descriptive purposes, and are not intended to limit the scope of the present disclosure in any way. Specifically, in practice, the primary ECU 200 may include more or less components than as illustrated in FIG. 2, and/or may be arranged in a manner different from as illustrated in FIG. 2, without departing from the scope of the present disclosure. For example, the VM partition 3 260 may be split into two separate partitions, one for Android Auto and another for Apple CarPlay. Further, other ECUs within the vehicle may also include a plurality of partitions

The secondary ECU may serve as a ramdisk of the primary ECU. The ramdisk may refer to an in-memory only virtual filesystem which does not persist, where the memory of the secondary ECU may be configured to serve as a ramdisk for the primary ECU. According to example embodiments, any files that the user 110 would like to persist between builds may exist in the memory disk of the secondary ECU. Further, the files stored in the memory disk of the secondary ECU may be exported outside of the VSD system 120 (e.g., to the user 110's device). Such configuration provides the primary ECU with a non-persistent memory with minimal slowdown while having sufficient space for execution of a software in memory.

The primary ECU and the secondary ECU may be communicatively coupled via any interface. According to example embodiments, the primary ECU and the secondary ECU may be communicatively coupled via a high-speed bus, such as a Peripheral Component Interconnect (PCI) Express.

The production configuration of the vehicle may refer to a configuration of the vehicle where only all subsystems of the vehicle are unlocked for access by a driver to operate the vehicle. In particular, the production configuration may unlock all partitions of all ECUs of the vehicle for access by the driver, such that the driver may operate the vehicle.

Each of the development configuration and the production configuration may be associated with a cryptographic key, where the development configuration and the production configuration may be initiated when the associated cryptographic key is received by the VSD system 120.

For example, the driver may possess a physical or digital key that contains a cryptographic production asymmetric key (e.g., Elliptic Curve Cryptography). Such cryptographic key may be associated with the production configuration (i.e., production key) such that, when the driver provides the VSD system 120 with the production key (i.e., key for driving and operating the vehicle in production configuration), the vehicle may start and all subsystems of the vehicle may be unlocked in order to allow the driver to operate the vehicle. In particular, a hypervisor in the root partition 210 of the primary ECU 200 may be booted and may then use the production key to unlock the key partition 200 of the primary ECU 200 in order to decrypt all keys contained in the key partition 200 (i.e., keys for unlocking each of the partitions of the primary ECU 200). In other words, the production key can unlock all partitions of the primary ECU 200. The hypervisor may then decrypt and use a production configuration for the VMs, as well as boot all the partitions appropriately.

On the other hand, the user 110 (software developer) may possess a physical or digital key that contains a cryptographic non-production asymmetric key (e.g., Elliptic Curve Cryptography). Such cryptographic key may be associated with the development configuration (i.e., development key) such that, when the user 110 provides the VSD system 120 with the development key (i.e., key for developing a vehicle software), only a portion of the subsystems of the vehicle may be unlocked. In particular, a hypervisor in the root partition 210 of the primary ECU 200 may be booted and may then use the development key to unlock the key partition 200 of the primary ECU 200 in order to decrypt only a portion of the keys contained in the key partition 200 (i.e., keys for unlocking a portion of the partitions of the primary ECU 200). In other words, the development key can unlock only a portion of the partitions of the primary ECU 200. The hypervisor may then decrypt and use a development configuration to start the VMs in the unlocked partitions, where the entire filesystem may be read-only when the VMs start. The development key may not unlock the partitions related to safety critical VMs or functionalities, which means the vehicle may power on but may be unable to shift modes into drive.

In this regard, in order to determine whether a cryptographic key received by the VSD system is the development key, the production key, or neither, the cryptographic key received by the VSD system may be validated. According to example embodiments, the received cryptographic key may be validated based on one or more public keys stored in a memory of the VSD system. In particular, the development key and the production key included in the physical/digital key may be private keys. In this regard, for example, once the physical key is inserted into the key slot of the vehicle, the cryptographic key (i.e., private key) may generate and send a challenge to the VSD system, where the one or more public keys stored in the memory of the VSD system may be used to validate the received cryptographic key. If the received cryptographic key is associated with any of the one or more public keys stored in the memory of the VSD system, the received cryptographic key may be successfully validated and identified.

Accordingly, if the received cryptographic key is associated with a public key that is associated with the development configuration (development public key), the received cryptographic key may be successfully validated and identified as the development key, where the VSD system may accordingly initiate the development configuration. Similarly, if the received cryptographic key is associated with a public key that is associated with the production configuration (production public key), the received cryptographic key may be successfully validated and identified as the production key, where the VSD system may accordingly initiate the production configuration. On the other hand, if the received cryptographic key is not associated with any of the one or more public keys stored in the memory of the VSD system, the received cryptographic key may be identified as being neither the development key nor the production key, and may not be successfully validated. Subsequently, the vehicle may not start any of its subsystems.

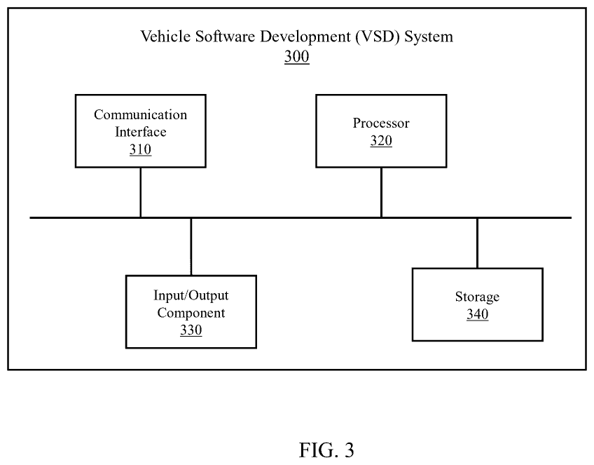

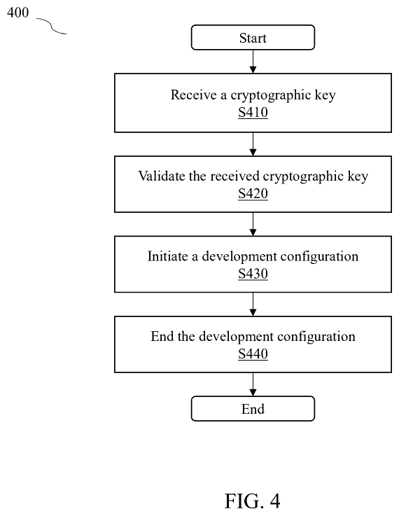

Several example components which may be included in the VSD system 120, according to one or more embodiments, are described below with reference to FIG. 3. Further, example operations performable by the VSD system 120 for developing a vehicle software are described below with reference to FIG. 4 to FIG. 7.

As further shown in FIG. 1, the VSD system 120 may communicate with a user 110. According to example embodiments, the user 110 may include a software/application developer that is developing a software/application for the vehicle (i.e., the VSD system 120 or the vehicle where the VSD system 120 is installed in).

Further, the user 110 may communicate with the VSD system 120 using any means. For example, as described above, when performing cryptographic key validation, the user 110 may insert a physical key containing a cryptographic key to a key slot in a vehicle in order to provide the cryptographic key to the VSD system 120. In another example, when performing software development for the vehicle, the user 110 may communicate with the VSD system 120 through a device, such as development kit, personal computer (PC), and the like, that is connected to the VSD system 120 via an interface, such as Universal Serial Bus (USB). In such case, the USB port on the IVI may be unlocked in the development configuration. Further, the device that is connected to the VSD system 120 may be cryptographically validated. For example, the development kit may connect to the VSD system 120 via the USB using a challenge signed by public key.

It may be understood that the above descriptions are provided for descriptive purposes, and are not intended to limit the scope of the present disclosure in any way. Specifically, in practice, the user 110 may utilize any means to provide the cryptographic key to the VSD system 120 (e.g., digital key, touch sensor, and the like), and may utilize any kind of devices and interfaces in order to communicate with the VSD system 120 when developing a software.

FIG. 3 illustrates a block diagram of example components in a VSD system 300, according to one or more embodiments. The VSD system 300 may correspond to the VSD system 120 in FIG. 1, thus the features associated with the VSD system 120 and the VSD system 300 may be similarly applicable to each other, unless being explicitly described otherwise.

As illustrated in FIG. 3, the VSD system 300 may include at least one communication interface 310, at least one processor 320, at least one input/output component 330, and at least one storage 340, although it can be understood that the VSD system 300 may include more or less components than as illustrated in FIG. 3, and/or may be arranged in a manner different from as illustrated in FIG. 3, without departing from the scope of the present disclosure.

The communication interface 310 may include at least one transceiver-like component (e.g., a transceiver, a separate receiver and transmitter, a bus, etc.) that enables the components of the VSD system 300 to communicate with each other and/or to communicate with one or more components external to the VSD system 300, such as via a wired connection, a wireless connection, or a combination of wired and wireless connections. For example, the communication interface 310 may include an Ethernet interface, an optical interface, a coaxial interface, an infrared interface, a radio frequency (RF) interface, a universal serial bus (USB) interface, a Wi-Fi interface, a cellular network interface, or the like.

For instance, the communication interface 310 may couple the processor 320 to the storage 340 to thereby enable them to communicate and to interoperate with each other in performing one or more operations. As another example, communication interface 310 may couple the VSD system 300 (or one or more components included therein) to the user 110, so as to enable them to communicate with each other.

According to one or more embodiments, the communication interface 310 may include one or more application programming interfaces (APIs) which allow the VSD system 300 (or one or more components included therein) to communicate with one or more software applications (e.g., software application deployed in a device utilized by the user 110, etc.).

The input/output component 330 may include at least one component that permits the VSD system 300 to receive information and/or to provide output information. It can be understood that, in some embodiments, the input/output component 330 may include at least one input component (e.g., a touch screen display, a keyboard, a keypad, a mouse, a button, a switch, a microphone, etc.) and at least one output component (e.g., a display, a speaker, one or more light-emitting diodes (LEDs), etc.), each of which may be separated from each other. Additionally, or alternatively, the at least one input component may include a sensor for sensing information (e.g., a global positioning system (GPS) component, an accelerometer, a gyroscope, and/or an actuator).

The storage 340 may include one or more storage mediums suitable for storing data, information, and/or computer-executable instructions therein. According to example embodiments, the storage 340 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 320. Additionally or alternatively, the storage 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. A computer-readable medium is defined herein as a non-transitory memory device. A memory device includes memory space within a single physical storage device or memory space spread across multiple physical storage devices.

According to example embodiments, the storage 340 may be configured to store information, such as raw data, metadata, or the like. Additionally or alternatively, the storage 340 may be configured to store one or more information associated with one or more operations performed by the processor 320. For instance, the storage 340 may store information defining the historical operation(s) performed by the processor 320 to develop a vehicle software, one or more results of operations performed by the processor 320, or the like. Further, the storage 340 may store data or information required in developing a vehicle software.

In some implementation, the storage 340 may include a plurality of storage mediums, and the storage 340 may be configured to store a duplicate or a copy of at least a portion of the information in the plurality of storage mediums, for providing redundancy and for backing-up the information or the associated data. Furthermore, the storage 340 may also store computer-readable or computer-executable instructions which, when being executed by one or more processors (e.g., processor 320), causes the one or more processors to perform one or more actions/operations described herein

The processor 320 may include at least one processor capable of being programmed or being configured to perform a function(s) or an operation(s) described herein. For instance, the processor 320 may be configured to execute computer-executable instructions stored in at least one storage medium or a memory storage (e.g., storage 340, etc.) to thereby perform one or more actions or one or more operations described herein.

According to example embodiments, the processor 320 may be configured to receive (e.g., via the communication interface 310, via the input/output component 330, etc.) one or more signals and/or one or more user inputs defining one or more instructions for performing one or more operations. Further, the processor 320 may be implemented in hardware, firmware, or a combination of hardware and software. For instance, processor 320 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to example embodiments, the processor 320 may be configured to collect, to extract, and/or to receive one or more information (in the form of signal or data, etc.) from the user 110, and to process the received one or more information to thereby develop a vehicle software.

The number and arrangement of components shown in FIG. 3 are provided as an example. In practice, VSD system 300 may include additional components, fewer components, different components, or differently arranged components than those shown in FIG. 3. Additionally, or alternatively, a set of components (e.g., one or more components) of VSD system 300 may perform one or more functions described as being performed by another set of components of VSD system 300.

Descriptions of several example operations which may be performed by the processor 320 are provided below with reference to FIG. 4 to FIG. 7.

### Example Operations for Developing a Vehicle Software in the Present Disclosure

In the following, several example operations performable by the VSD system of the present disclosure are described with reference to FIG. 4 to FIG. 7.

FIG. 4 illustrates a flow diagram of an example method 400 for developing a vehicle software, according to one or more embodiments. One or more operations in method 400 may be performed by at least one processor (e.g., processor 320) of the VSD system.

As illustrated in FIG. 4, at operation S410, the at least one processor may be configured to receive a cryptographic key. According to example embodiments, the cryptographic key may include a development key. According to example embodiments, the cryptographic key may be a private key. According to example embodiments, the cryptographic key may be received from a user. For example, the user may insert a physical key containing the cryptographic key into a key slot of a vehicle. The method proceeds to operation S420.

At operation S420, the at least one processor may be configured to validate the received cryptographic key. According to example embodiments, the received cryptographic key may be validated based on one or more public keys stored in a memory of the VSD system. The method then proceeds to operation S430.

At operation S430, in response to successfully validating the received cryptographic key, the at least one processor may be configured to initiate a development configuration of a vehicle. According to example embodiments, the development configuration of the vehicle may refer to a configuration of the vehicle where only a portion of subsystems of the vehicle are unlocked for access by the user to perform vehicle software development on the vehicle. According to example embodiments, the development configuration may include a primary electronic control unit (ECU) in the vehicle and a secondary ECU in the vehicle, where the primary ECU may include a plurality of partitions, and the secondary ECU may serve as a ramdisk of the primary ECU. According to example embodiments, the plurality of partitions of the primary ECU may include one or more of: a partition including a hypervisor, a partition including encrypted keys, a partition including a configuration data, a partition including a virtual machine related to safety related functionalities of the vehicle, a partition including a virtual machine related to non-safety related functionalities of the vehicle, a partition including a virtual machine related to software development framework, and a partition including user data.

According to example embodiments, the primary ECU and the secondary ECU may be communicatively coupled via an interface, such as a Peripheral Component Interconnect (PCI) Express interface. According to example embodiments, the received cryptographic key may be successfully validated if the received cryptographic key is associated with a development public key. The development public key may be stored in the memory of the VSD system, and may be associated with the development configuration.

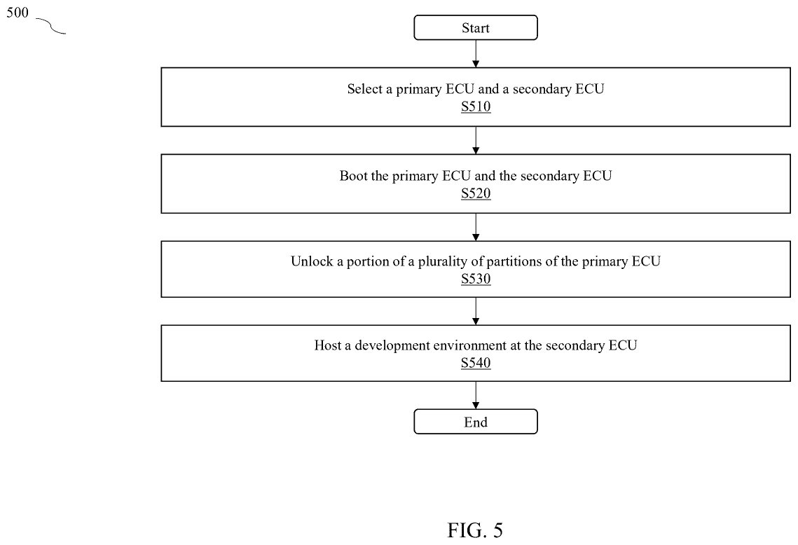

Examples of operations for initiating the development configuration of the vehicle are described below with reference to FIG. 5.

Accordingly, the above process allows the user to develop software/applications directly on the vehicle, without requiring specialized hardware and tooling. Further, since the development configuration is initiated after a successful validation of the cryptographic key and only a portion of subsystems of the vehicle are unlocked for access by the user to perform vehicle software development on the vehicle, the above process prevents harmful access to the vehicle that may compromise the security of the vehicle. The method then proceeds to operation S440.

At operation S440, in response to detecting a removal of the received cryptographic key from the vehicle, the at least one processor may be configured to end the development configuration and delete a memory of the secondary ECU. In particular, according to example embodiments, after the development configuration of the vehicle is initiated, the at least one processor may be configured to monitor the received cryptographic key in order to detect a removal of the received cryptographic key from the vehicle. For example, the user may complete developing a vehicle software while the vehicle is in the development configuration and then remove the physical key containing the cryptographic key from the key slot of the vehicle. Accordingly, in response to detecting the removal of the received cryptographic key from the vehicle, the development configuration may be ended and the memory of the secondary ECU may be deleted. According to example embodiments, the development configuration may be ended by powering down the primary ECU and the secondary ECU.

Upon performing operation S440, the method 400 may be ended or be terminated. Alternatively, method 400 may return to operation S410, such that the at least one processor may be configured to repeatedly perform, for at least a predetermined amount of time, the receiving the cryptographic key (at operation S410), the validating the received cryptographic key (at operation S420), the initiating the development configuration (at operation S430), and the ending the development configuration (at operation S440). For instance, the at least one processor may continuously (or periodically) receive more cryptographic keys, and then restart the receiving the cryptographic key (at operation S410), the validating the received cryptographic key (at operation S420), the initiating the development configuration (at operation S430), and the ending the development configuration (at operation S440).

### Example Operations for Initiating a Development Configuration of a Vehicle in the Present Disclosure

FIG. 5 illustrates a flow diagram of an example method 500 for initiating a development configuration of a vehicle, according to one or more embodiments. One or more operations of method 500 may be part of operation S430 in method 400, and may be performed by at least one processor (e.g., processor 320) of the VSD system.

As illustrated in FIG. 5, at operation S510, the at least one processor may be configured to select a primary ECU and a secondary ECU. The primary ECU and the secondary ECU may be selected based on a predefined configuration file. According to example embodiments, the predefined configuration file may specify one ECU from among a plurality of ECUs in a vehicle as the primary ECU, and may specify another ECU from among a plurality of ECUs in a vehicle as the secondary ECU. Accordingly, the primary ECU and the secondary ECU may be selected from among the plurality of ECUs in the vehicle based on the predefined configuration file. According to example embodiments, the predefined configuration file may be predefined by a vehicle manufacturer and the like and may be stored in a memory of the VSD system. The method then proceeds to operation S520.

At operation S520, the at least one processor may be configured to boot the selected primary ECU and the selected secondary ECU. According to example embodiments, the primary ECU may be booted first, and the primary ECU may then send a command to the secondary ECU. The command may instruct the secondary ECU to boot using its memory as a ramdisk. According to example embodiments, the secondary ECU may boot using its memory as the ramdisk without unlocking any of its physical partitions. The method then proceeds to operation S530.

At operation S530, the at least one processor may be configured to unlock a portion of the plurality of partitions of the primary ECU. According to example embodiments, the unlocked portion of the plurality of partitions of the primary ECU may include one or more of: a partition including a virtual machine related to non-safety related functionalities of the vehicle, a partition including a virtual machine related to software development framework, and a partition including user data. According to example embodiments, the unlocked portion of the plurality of partitions of the primary ECU may be read only. The method then proceeds to operation S540.

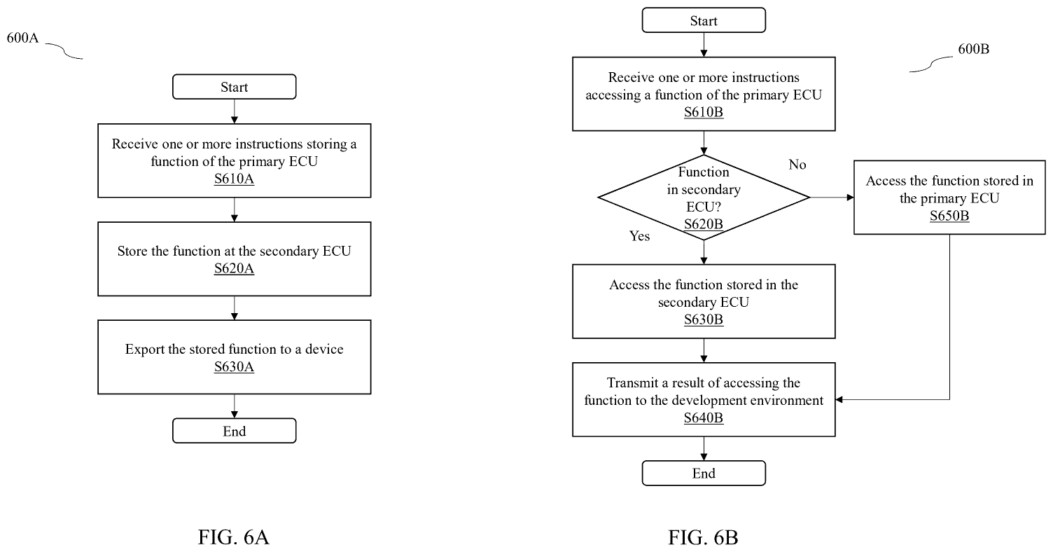

At operation S540, the at least one processor may be configured to host a development environment at the secondary ECU. According to example embodiments, the development environment may be hosted at the secondary ECU by loading a developer tool in the memory of the secondary ECU in order to create the development environment. Examples of operations for hosting the development environment at the secondary ECU are described below with reference to FIGS. 6A and 6B.

### Example Operations for Hosting a Development Environment at a Secondary ECU in the Present Disclosure

FIG. 6A illustrates a flow diagram of an example method 600A for hosting a development environment at a secondary ECU, according to one or more embodiments. One or more operations of method 600A may be part of operation S540 in method 500, and may be performed by at least one processor (e.g., processor 320) of the VSD system.

As illustrated in FIG. 6A, at operation S610A, the at least one processor may be configured to receive one or more instructions for storing a function of the primary ECU. The received one or more instructions may be received at the development environment (i.e., hosted at the secondary ECU) from a user. According to example embodiments, the one or more instructions may be received from the user via a development kit that is connected to the VSD system using USB interface. According to example embodiments, the one or more instructions may include a write syscall.

According to example embodiments, the function of the primary ECU may be a new function that does not currently exist at the primary ECU. According to example embodiments, the function of the primary ECU may be a modified version of a function that currently exists at the primary ECU.

For example, the user may want to modify a function of the primary ECU for the purpose of developing and/or testing a vehicle software on the vehicle. In this regard, since the unlocked partitions of the primary ECU is read only, the user may modify the function of the primary ECU, and store such modified function of the primary ECU on the secondary ECU. Accordingly, when the user would like to access such modified function, the VSD system may access the modified function stored at the secondary ECU rather than the unmodified function stored at the primary ECU (see below in relation to method 600B). The method then proceeds to operation S620A.

At operation S620A, the at least one processor may be configured to store the function at the secondary ECU.

According to example embodiments, the at least one processor may be configured to further update a memory stack of the primary ECU to include a reference to the function of the primary ECU stored at the secondary ECU. Accordingly, for example, any access to the function of the primary ECU may be rerouted to the modified function of the primary ECU stored at the secondary ECU rather than the unmodified function stored at the primary ECU. The method then proceeds to operation S630A.

At operation S630A, the at least one processor may be configured to export the stored function to a device. According to example embodiments, the device may include a device external to the VSD system.

For example, once the user completes the development and/or testing of the vehicle software on the vehicle utilizing the function of the primary ECU stored at the secondary ECU, the VSD system may export such stored function of the primary ECU to an external device (e.g., development kit, development personal computer, and the like), such that the user may further develop the vehicle software.

FIG. 6B illustrates a flow diagram of an example method 600B for hosting a development environment at a secondary ECU, according to one or more embodiments. One or more operations of method 600B may be part of operation S540 in method 500, and may be performed by at least one processor (e.g., processor 320) of the VSD system.

As illustrated in FIG. 6B, at operation S610B, the at least one processor may be configured to receive one or more instructions accessing a function of the primary ECU. The received one or more instructions may be received at the development environment (i.e., hosted at the secondary ECU) from a user. According to example embodiments, the one or more instructions may be received from the user via a development kit that is connected to the VSD system using USB interface. According to example embodiments, the one or more instructions may include a read syscall.

According to example embodiments, the primary ECU may be associated with a plurality of functions of the vehicle, and the plurality of functions may be accessed by the user via the development environment and the unlocked portion of the plurality of partitions of the primary ECU. The method then proceeds to operation S620B.

At operation S620B, the at least one processor may be configured to determine whether the function is stored in the secondary ECU.

In particular, as described above in relation to operation S620A in method 600A, the user may want to modify and/or add a function of the primary ECU for the purpose of developing and/or testing a vehicle software on the vehicle, where such function may be stored at the secondary ECU. In this regard, at operation S620B, the at least one processor may be configured to determine whether the function which the user would like to access during operation S610B is stored in the secondary ECU (i.e., whether the function the user would like to access during operation S610B is a new function/modified function stored in the secondary ECU or is an original/unmodified function stored in the primary ECU).

Accordingly, in response to determining that the function is stored in the secondary ECU, the at least one processor may determine that the function the user would like to access during operation S610B is a new function/modified function stored in the secondary ECU, and the method proceeds to operation S630B. On the other hand, in response to determining that the function is not stored in the secondary ECU, the at least one processor may determine that the function the user would like to access during operation S610B is an original/unmodified function stored in the primary ECU, and the method proceeds to operation S650B.

At operation S630B, the at least one processor may be configured to access the function stored in the secondary ECU. Similarly, at operation S650B, the at least one processor may be configured to access the function stored in the primary ECU. The method then proceeds to operation S640B.

At operation S640B, the at least one processor may be configured to transmit a result of accessing the function to the development environment. According to example embodiments, the result of accessing the function may be obtained from the primary ECU. Accordingly, the user may receive feedbacks for the development and/or testing of the vehicle software on the vehicle.

According to example embodiments, one or more operations from method 600A and 600B may be combined.

For example, the at least one processor may receive one or more instructions for storing a function of the primary ECU, where operations S610A and S620A may be performed. Then the at least one processor may receive one or more instructions accessing a function of the primary ECU, where operations S610B to S640B may be performed before operation S630A is performed.

### Example Flow for Developing a Vehicle Software in the Present Disclosure

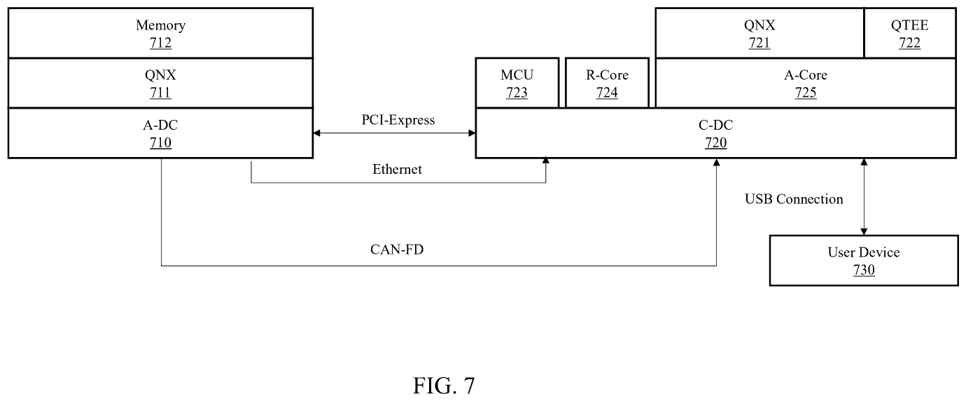

FIG. 7 illustrates diagram of example interactions between a primary ECU, a secondary ECU, and a user device, according to one or more embodiments.

As shown in FIG. 7, an Advanced Driver Assistance System (ADAS) Domain Controller (A-DC) ECU 710 of a vehicle may correspond to the secondary ECU, and may include a QNX operating system 711 and a memory 712. The memory 712 of the secondary ECU may serve as a ramdisk of the primary ECU, and may host the development environment.

Further, a Cockpit Domain Controller (C-DC) ECU 720 of the vehicle may correspond to the primary ECU. Further, the C-DC ECU 720 may include a QNX operating system 721, a Qualcomm Trusted Execution Environment (QTEE) 722, a microcontroller unit (MCU) 723, an Advanced Reduced Instruction Set Computer Machine (ARM) processor R-core 724, and an ARM processor A-core 724. The disk of the A-core 724 may be read only during the development configuration.

The C-DC ECU 720 may be communicatively coupled to the A-DC ECU 710 via a PCI Express, Ethernet, and Controller Area Network (CAN) Flexible Data (FD). In particular, the communications between the C-DC ECU 720 and the A-DC ECU 710 via the PCI Express may be managed by the R-core 724. Further, the C-DC ECU 720 may be communicatively coupled to a user device 730 via USB connection.

An example flow for developing a vehicle software may begin with a user inserting a physical key into a key slot of a vehicle. The private key in the physical key generates and sends a challenge to the vehicle upon being plugged in and turned on. Value is validated by public keys stored in eFuse. Here, the private key may be the development key.

Subsequently, the development public key is used to decrypt or unlock partitions of the primary ECU. The development public key unlocks only a portion of the partitions in read only and cannot unlock any safety relevant partition. Hardware Security Module (HSM) or Secure Partition may be used to store the keys. QNX 721 is then informed (i.e., based on the predefined configuration file) which ECU to serve as a ramdisk (i.e., second ECU/A-DC ECU 710), where the A-DC ECU 710 then begins to boot.

The developer tools are loaded in the memory of the A-DC ECU 710 to create a development environment. Once the development environment is created, the development kit reaches out, using a challenge signed by public key, to the development environment via the user device 730 that is connected to the C-DC ECU 720 using USB connection.

Here, the user validates the signature on the user device 730 and begins developing/testing a vehicle software. In particular, the user can use the ramdisk to persist, as well as calling and receiving responses from functions of the C-DC ECU 720. It may be understood that the functions accessible by the user are not safety critical. Further, since the functions are read only, the user may modify the function or add a new function by writing a modified/new function onto the memory 712 (i.e., ramdisk). Once the modified/new function is written, the A-DC ECU 710 may update the memory stack on C-DC ECU 720 to include a reference to the modified/new function so any call to the function would be routed to the new modified/new function.

When the user completes the development/testing, the user can save the contents of the memory 712 to the user device 730. The user device 730 can then be disconnected and the development key can be removed. Subsequently, the memory 712 is wiped and the vehicle powers down. The user can then use the content of the memory 712 (e.g., developed codes) to obtain verification and certification, where such content would go to the vehicle eventually.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a memory storage storing computer-executable instructions; and
at least one processor communicatively coupled to the memory storage, wherein the at least one processor is configured to execute the instructions to:
receive a cryptographic key;
validate the received cryptographic key;
in response to successfully validating the received cryptographic key, initiate a development configuration of a vehicle, wherein the development configuration comprises a primary electronic control unit (ECU) in the vehicle including a plurality of partitions, and a secondary ECU in the vehicle serving as a ramdisk of the primary ECU; and
in response to detecting a removal of the received cryptographic key from the vehicle, end the development configuration and delete a memory of the secondary ECU.

2. The system according to claim 1, wherein the at least one processor is configured to execute the instructions to initiate the development configuration by selecting the primary ECU and the secondary ECU based on a predefined configuration file.

3. The system according to claim 1, wherein the primary ECU and the secondary ECU are communicatively coupled via a Peripheral Component Interconnect (PCI) Express interface.

4. The system according to claim 1, wherein the at least one processor is configured to execute the instructions to initiate the development configuration by unlocking a portion of the plurality of partitions of the primary ECU.

5. The system according to claim 4, wherein the unlocked portion of the plurality of partitions of the primary ECU comprises one or more of: a partition including a virtual machine related to non-safety related functionalities of the vehicle, a partition including a virtual machine related to software development framework, and a partition including user data.

6. The system according to claim 5, wherein the at least one processor is configured to execute the instructions to initiate the development configuration further by hosting a development environment at the secondary ECU.

7. The system according to claim 6, wherein the primary ECU is associated with a plurality of functions of the vehicle, and wherein the plurality of functions are accessed by a user via the development environment and the unlocked portion of the plurality of partitions of the primary ECU.

8. The system according to claim 6, wherein the at least one processor is configured to execute the instructions to host the development environment by:
receiving one or more instructions storing a function of the primary ECU at the development environment from a user;
storing the function at the secondary ECU; and
exporting the stored function to a device.

9. The system according to claim 6, wherein the at least one processor is configured to execute the instructions to host the development environment by:
receiving one or more instructions accessing a function of the primary ECU at the development environment from a user;
determining whether the function is stored in the secondary ECU;
in response to determining that the function is stored in the secondary ECU, accessing the function stored in the secondary ECU;
in response to determining that the function is not stored in the secondary ECU, accessing the function stored in the primary ECU; and
transmitting a result of accessing the function to the development environment.

10. A method comprising:
receiving a cryptographic key;
validating the received cryptographic key;
in response to successfully validating the received cryptographic key, initiating a development configuration of a vehicle, wherein the development configuration comprises a primary electronic control unit (ECU) in the vehicle including a plurality of partitions, and a secondary ECU in the vehicle serving as a ramdisk of the primary ECU; and
in response to detecting a removal of the received cryptographic key from the vehicle, ending the development configuration and deleting a memory of the secondary ECU.

11. The method according to claim 10, wherein the initiating the development configuration comprises selecting the primary ECU and the secondary ECU based on a predefined configuration file.

12. The method according to claim 10, wherein the primary ECU and the secondary ECU are communicatively coupled via a Peripheral Component Interconnect (PCI) Express interface.

13. The method according to claim 10, wherein the initiating the development configuration comprises unlocking a portion of the plurality of partitions of the primary ECU.

14. The method according to claim 13, wherein the unlocked portion of the plurality of partitions of the primary ECU comprises one or more of: a partition including a virtual machine related to non-safety related functionalities of the vehicle, a partition including a virtual machine related to software development framework, and a partition including user data.

15. The method according to claim 14, wherein the initiating the development configuration further comprises hosting a development environment at the secondary ECU.

16. The method according to claim 15, wherein the primary ECU is associated with a plurality of functions of the vehicle, and wherein the plurality of functions are accessed by a user via the development environment and the unlocked portion of the plurality of partitions of the primary ECU.

17. The method according to claim 15, wherein the hosting the development environment comprises:
receiving one or more instructions storing a function of the primary ECU at the development environment from a user;
storing the function at the secondary ECU; and
exporting the stored function to a device.

18. The method according to claim 15, wherein the hosting the development environment comprises:
receiving one or more instructions accessing a function of the primary ECU at the development environment from a user;
determining whether the function is stored in the secondary ECU;
in response to determining that the function is stored in the secondary ECU, accessing the function stored in the secondary ECU;
in response to determining that the function is not stored in the secondary ECU, accessing the function stored in the primary ECU; and
transmitting a result of accessing the function to the development environment.

19. A non-transitory computer-readable recording medium having recorded thereon instructions executable by at least one processor to cause the at least one processor to perform a method comprising:
receiving a cryptographic key;
validating the received cryptographic key;
in response to successfully validating the received cryptographic key, initiating a development configuration of a vehicle, wherein the development configuration comprises a primary electronic control unit (ECU) in the vehicle including a plurality of partitions, and a secondary ECU in the vehicle serving as a ramdisk of the primary ECU; and
in response to detecting a removal of the received cryptographic key from the vehicle, ending the development configuration and deleting a memory of the secondary ECU.

20. The non-transitory computer-readable recording medium according to claim 19, wherein the initiating the development configuration comprises selecting the primary ECU and the secondary ECU based on a predefined configuration file.
